(19) United States
(12) Patent Application Publication
(10) Pub. No.: US 2013/0117162 A1
(43) Pub. Date: May 9, 2013

(54) METHOD FOR FAIR SHARE ALLOCATION IN A MULTI-ECHELON SERVICE SUPPLY CHAIN THAT CONSIDERS SUPERCESSION AND REPAIR RELATIONSHIPS

(71) Applicants: TAO FENG, San Jose, CA (US); Mei Yang, San Ramon, CA (US); Jeroen Dirks, Toronto, CA (US); Zhisu Zhu, San Jose, CA (US); Mukundan Srinivasan, Union City, CA (US)

(72) Inventors: TAO FENG, San Jose, CA (US); Mei Yang, San Ramon, CA (US); Jeroen Dirks, Toronto, CA (US); Zhisu Zhu, San Jose, CA (US); Mukundan Srinivasan, Union City, CA (US)

(73) Assignee: Oracle International Corporation, Redwood Shores, CA (US)

(21) Appl. No.: 13/480,850

(22) Filed: May 25, 2012

Related U.S. Application Data
(60) Provisional application No. 61/556,383, filed on Nov. 7, 2011.

(51) Int. Cl. G06Q 10/08

(52) U.S. Cl. 705/28

(57) ABSTRACT

Embodiments of the invention provide systems and methods for fair share allocation of inventory levels throughout a supply chain. According to one embodiment, a first round main Linear Programming (LP) solve can generate an initial solution. Post-processing heuristics for fair sharing can be applied to the first round solve of the main LP. Circular sourcing heuristics can be applied to the first round solve when adjusting for fair sharing allocation requirements. For example, applying the circular sourcing heuristics to the first round solve of the main LP can comprise determining a firmed supply surplus and shortage based on a demand picture from the first round solve of the main LP adjusted for fair sharing. A second round main LP solve can be executed using the fixed inter-organizational transfer variables and fixed supply towards independent demand variables from the post-processing heuristics.

### CROSS-REFERENCES TO RELATED APPLICATIONS

The present application claims benefit under 35 USC 119(e) of U.S. Provisional Application No. 61/556,383, filed on Nov. 7, 2011 by Feng et al. and entitled “A Method for Fair Share Allocation in a Multi-Echelon Service Supply Chain that Considers Supercession and Repair Relationships,” of which the entire disclosure is incorporated herein by reference for all purposes.

### BACKGROUND OF THE INVENTION

Embodiments of the present invention relate generally to methods and systems for inventory management and more particularly to allocation of inventory levels throughout a supply chain.

In a multi-echelon supply chain network, demands can occur for many items at one or more internal organizations or customer locations. The source(s) of supplies to meet the demands can come from one or more upstream internal organizations or suppliers. Often times, the demands from the multiple destinations compete for the supplies from the source organization(s) and/or suppliers. If the available supply is less than the demands, the allocations are typically based on demand priority. If there are multiple demands with the same priority, the sequence and amount to fulfill the demands may be random. It is possible that some demands are met completely on time while others do not get any supplies allocated.

Some software solutions provide the ability to “fair share” supplies across competing demands. This is done either based on a user specified percentage or based on the ratio of demand quantities. However, they do this on an item by item basis and offer very limited or no capabilities when the competing demands are for different items and/or come from different locations. They also do not provide the ability to consider supplies that may come from multiple items that are substitutable. In addition, in a service or distribution supply chain, the source for a supply may come from locations upstream (i.e., a different tier) or from locations at the same tier (circular source) where surplus inventory can be shared of allocated. Hence, there is a need for improved methods and systems for fair share allocation of inventory levels throughout a multi-echelon supply chain and across competing demands in the supply chain.

### BRIEF SUMMARY OF THE INVENTION

Embodiments of the invention provide systems and methods for fair share allocation of inventory levels throughout a supply chain. According to one embodiment, fair share allocation in a multi-echelon service supply chain that considers supercession and repair relationships can comprise executing a first round main Linear Programming (LP) solve generated initial solution. Post-processing heuristics for fair sharing can be applied to the first round solve of the main LP after executing the first round solve of the main LP. Circular sourcing heuristics can be applied to the first round solve of the main LP when adjusting the first round solve of the main LP for fair sharing allocation requirements. For example, applying the circular sourcing heuristics to the first round solve of the main LP can comprise determining a firmed supply surplus and shortage based on a demand picture from the first round solve of the main LP adjusted for fair sharing. A second round main LP solve can be executed using the fixed inter-organizational transfer variables and fixed supply towards independent demand variables from the post-processing heuristics.

Applying the post-processing heuristics can comprise using a push-down logic to generate a demand picture for each sourcing tier of a plurality of sourcing tiers. Using a push-down logic to generate a demand picture for each sourcing tier can comprises obtaining the supply information from the first round solve of the main LP, choosing a sourcing path of a plurality of sourcing paths of the supply chain, consuming the supply at each location for the selected path, applying supercession at each sourcing location of the selected path, pushing down the remaining demand quantity to a next sourcing tier, and linking a dependent demand to the original demand list for each time bucket, at each organization for each sourcing tier.

Applying the post-processing heuristics can further comprise using a bottom-up logic to adjust the first round solve of the main LP for fair sharing allocation requirements. In such cases, an output of the post-processing heuristics can comprise fixed inter-organizational transfer variables and fixed supply towards independent demand variables. Using a bottom-up logic to adjust the first round solve of the main LP for fair sharing allocation requirements can comprise identifying eligible competing demands, applying fair sharing of supply to those demands, performing bottom up processing to adjust downstream demand satisfaction, re-calculating unsatisfied demands, determining whether any unmet demand remains, and in response to determining unmet demand remains, repeatedly pushing down remaining demand quantities, applying fair sharing between the unmet demands, performing bottom up processing to adjust downstream demand satisfaction, and re-computing unsatisfied demand until no unmet demand remains.

### BRIEF DESCRIPTION OF THE DRAWINGS

FIG. 1 is a block diagram illustrating components of an exemplary operating environment in which various embodiments of the present invention may be implemented.

FIG. 2 is a block diagram illustrating an exemplary computer system in which embodiments of the present invention may be implemented.

FIG. 3 is a flowchart illustrating a process for fair share allocation of inventory levels throughout a supply chain according to one embodiment of the present invention.

FIG. 4 is a flowchart illustrating an exemplary push-down logic process for use in fair share allocation of inventory levels throughout a supply chain according to one embodiment of the present invention.

FIG. 5 is a flowchart illustrating an exemplary bottom-up process for use in fair share allocation of inventory levels throughout a supply chain according to one embodiment of the present invention.

### DETAILED DESCRIPTION OF THE INVENTION

In the following description, for the purposes of explanation, numerous specific details are set forth in order to provide a thorough understanding of various embodiments of the present invention. It will be apparent, however, to one skilled in the art that embodiments of the present invention may be practiced without some of these specific details. In other instances, well-known structures and devices are shown in block diagram form.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the invention as set forth in the appended claims.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

The term “machine-readable medium” includes, but is not limited to portable or fixed storage devices, optical storage devices, wireless channels and various other mediums capable of storing, containing or carrying instruction(s) and/or data. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

Embodiments of the present invention can include an algorithm to allocate available supply to competing demands while considering the complete supply chain network. The algorithm can address a concern in the service/spares planning industry, where it is very common to have several revisions of an item/product. Embodiments of the present invention can provide: the ability to consider competing demands that could be for different items/revisions; the ability to consider competing demands that could be from different locations; the ability to consider multiple sources and types of supply, including supplies of defectives that need to be repaired before it can be allocated to a demand; the ability to fair share across safety stock demands; selectively enforcing order modifiers and allowing it to be a soft constraint; the ability to use a different bucketing granularity for ‘fair share’ in contrast to the bucketing used for replenishment; and the ability to incorporate rebalancing decisions in-line with fair share. Rebalancing is the process by which locations that are near each other physically can share any excess inventory to allow for a better re-distribution (or rebalancing of excess) of inventory. This process allows inventory to flow in both directions between 2 or more locations.

These features significantly improve the quality of the solution generated by the planning system and helps the planner make the right decisions that address key business metrics such as service level and inventory costs. Embodiments of the present invention can be used, for example, to plan the spares/repair of the service business and help to increase the customer service level while minimizing inventory.

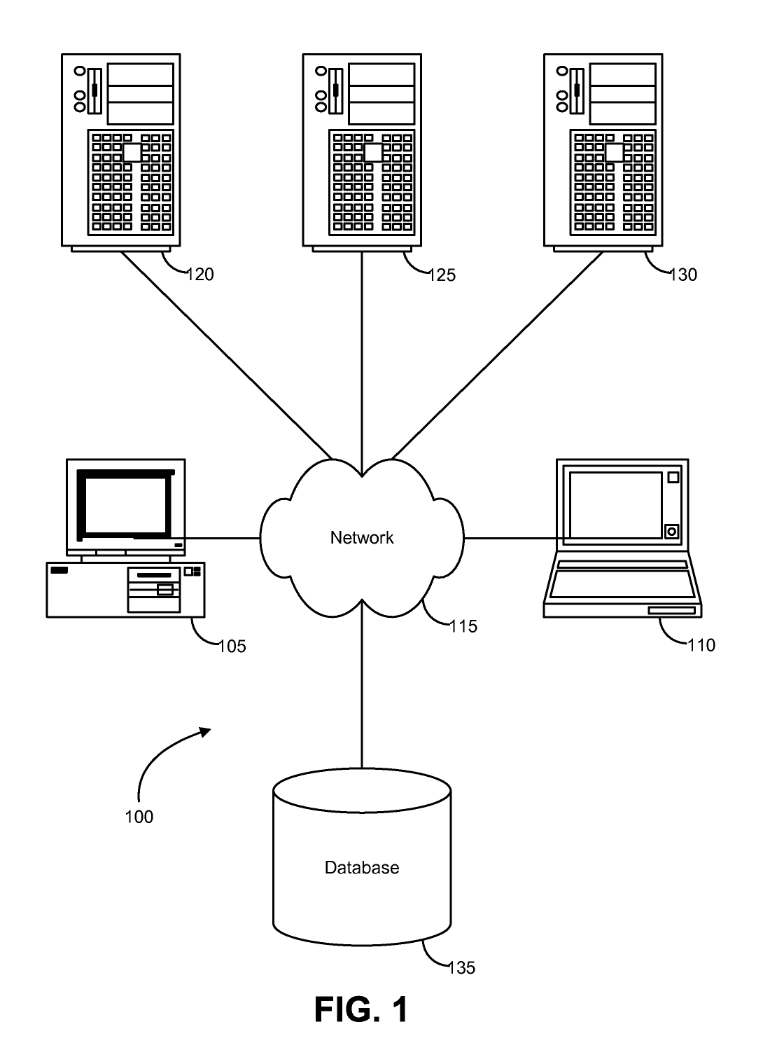

FIG. 1 is a block diagram illustrating components of an exemplary operating environment in which various embodiments of the present invention may be implemented. The system 100 can include one or more user computers 105, 110, which may be used to operate a client, whether a dedicate application, web browser, etc. The user computers 105, 110 can be general purpose personal computers (including, merely by way of example, personal computers and/or laptop computers running various versions of Microsoft Corp.'s Windows and/or Apple Corp.'s Macintosh operating systems) and/or workstation computers running any of a variety of commercially-available UNIX or UNIX-like operating systems (including without limitation, the variety of GNU/Linux operating systems). These user computers 105, 110 may also have any of a variety of applications, including one or more development systems, database client and/or server applications, and web browser applications. Alternatively, the user computers 105, 110 may be any other electronic device, such as a thin-client computer, Internet-enabled mobile telephone, and/or personal digital assistant, capable of communicating via a network (e.g., the network 115 described below) and/or displaying and navigating web pages or other types of electronic documents. Although the exemplary system 100 is shown with two user computers, any number of user computers may be supported.

In some embodiments, the system 100 may also include a network 115. The network may be any type of network familiar to those skilled in the art that can support data communications using any of a variety of commercially-available protocols, including without limitation TCP/IP, SNA, IPX, AppleTalk, and the like. Merely by way of example, the network 115 maybe a local area network (“LAN”), such as an Ethernet network, a Token-Ring network and/or the like; a wide-area network; a virtual network, including without limitation a virtual private network (“VPN”); the Internet; an intranet; an extranet; a public switched telephone network (“PSTN”); an infra-red network; a wireless network (e.g., a network operating under any of the IEEE 802.11 suite of protocols, the Bluetooth protocol known in the art, and/or any other wireless protocol); and/or any combination of these and/or other networks such as GSM, GPRS, EDGE, UMTS, 3G, 2.5 G, CDMA, CDMA2000, WCDMA, EVDO etc.

The system may also include one or more server computers 120, 125, 130 which can be general purpose computers and/or specialized server computers (including, merely by way of example, PC servers, UNIX servers, mid-range servers, mainframe computers rack-mounted servers, etc.). One or more of the servers (e.g., 130) may be dedicated to running applications, such as a business application, a web server, application server, etc. Such servers may be used to process requests from user computers 105, 110. The applications can also include any number of applications for controlling access to resources of the servers 120, 125, 130.

The web server can be running an operating system including any of those discussed above, as well as any commercially-available server operating systems. The web server can also run any of a variety of server applications and/or mid-tier applications, including HTTP servers, FTP servers, CGI servers, database servers, Java servers, business applications, and the like. The server(s) also may be one or more computers which can be capable of executing programs or scripts in response to the user computers 105, 110. As one example, a server may execute one or more web applications. The web application may be implemented as one or more scripts or programs written in any programming language, such as Java™, C, C# or C++, and/or any scripting language, such as Perl, Python, or TCL, as well as combinations of any programming/scripting languages. The server(s) may also include database servers, including without limitation those commercially available from Oracle®, Microsoft®, Sybase®, IBM® and the like, which can process requests from database clients running on a user computer 105, 110.

In some embodiments, an application server may create web pages dynamically for displaying on an end-user (client) system. The web pages created by the web application server may be forwarded to a user computer 105 via a web server. Similarly, the web server can receive web page requests and/or input data from a user computer and can forward the web page requests and/or input data to an application and/or a database server. Those skilled in the art will recognize that the functions described with respect to various types of servers may be performed by a single server and/or a plurality of specialized servers, depending on implementation-specific needs and parameters.

The system 100 may also include one or more databases 135. The database(s) 135 may reside in a variety of locations. By way of example, a database 135 may reside on a storage medium local to (and/or resident in) one or more of the computers 105, 110, 115, 125, 130. Alternatively, it may be remote from any or all of the computers 105, 110, 115, 125, 130, and/or in communication (e.g., via the network 120) with one or more of these. In a particular set of embodiments, the database 135 may reside in a storage-area network (“SAN”) familiar to those skilled in the art. Similarly, any necessary files for performing the functions attributed to the computers 105, 110, 115, 125, 130 may be stored locally on the respective computer and/or remotely, as appropriate. In one set of embodiments, the database 135 may be a relational database, such as Oracle 10 g, that is adapted to store, update, and retrieve data in response to SQL-formatted commands.

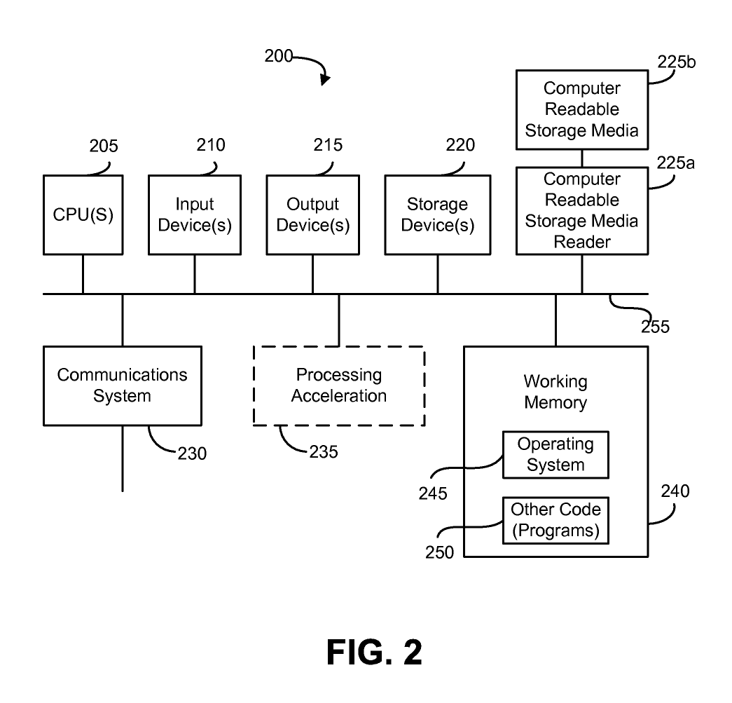

FIG. 2 illustrates an exemplary computer system 200, in which various embodiments of the present invention may be implemented. The system 200 may be used to implement any of the computer systems described above. The computer system 200 is shown comprising hardware elements that may be electrically coupled via a bus 255. The hardware elements may include one or more central processing units (CPUs) 205, one or more input devices 210 (e.g., a mouse, a keyboard, etc.), and one or more output devices 215 (e.g., a display device, a printer, etc.). The computer system 200 may also include one or more storage device 220. By way of example, storage device(s) 220 may be disk drives, optical storage devices, solid-state storage device such as a random access memory (“RAM”) and/or a read-only memory (“ROM”), which can be programmable, flash-updateable and/or the like.

The computer system 200 may additionally include a computer-readable storage media reader 225a, a communications system 230 (e.g., a modem, a network card (wireless or wired), an infra-red communication device, etc.), and working memory 240, which may include RAM and ROM devices as described above. In some embodiments, the computer system 200 may also include a processing acceleration unit 235, which can include a DSP, a special-purpose processor and/or the like.

The computer-readable storage media reader 225a can further be connected to a computer-readable storage medium 225b, together (and, optionally, in combination with storage device(s) 220) comprehensively representing remote, local, fixed, and/or removable storage devices plus storage media for temporarily and/or more permanently containing computer-readable information. The communications system 230 may permit data to be exchanged with the network 220 and/or any other computer described above with respect to the system 200.

The computer system 200 may also comprise software elements, shown as being currently located within a working memory 240, including an operating system 245 and/or other code 250, such as an application program (which may be a client application, web browser, mid-tier application, RDBMS, etc.). It should be appreciated that alternate embodiments of a computer system 200 may have numerous variations from that described above. For example, customized hardware might also be used and/or particular elements might be implemented in hardware, software (including portable software, such as applets), or both. Further, connection to other computing devices such as network input/output devices may be employed. Software of computer system 200 may include code 250 for implementing embodiments of the present invention as described herein.

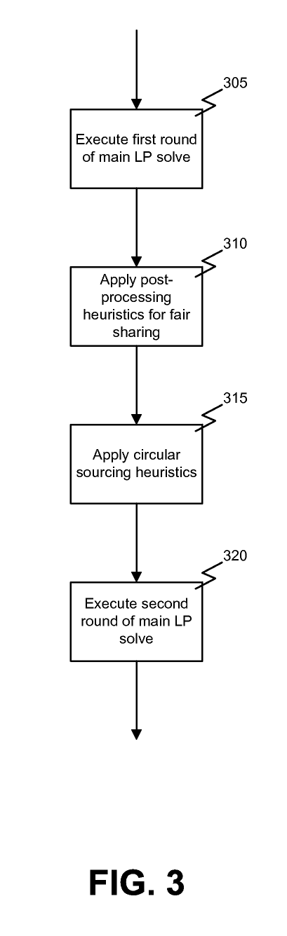

FIG. 3 is a flowchart illustrating a process for fair share allocation of inventory levels throughout a supply chain according to one embodiment of the present invention. As noted above, embodiments of the present invention can include a Supply Chain Management (SCM) application adapted to allocate available supply to competing demands while considering the complete supply chain network. As shown in the example illustrated by FIG. 3, this algorithm can be begin with executing 305 a first round main Linear Programming (LP) solve generated initial solution. In this stage, in case of insufficient supply, the process can satisfy one of the same-priority-demands completely, since the main LP doesn't consider fair-sharing allocation requirement.

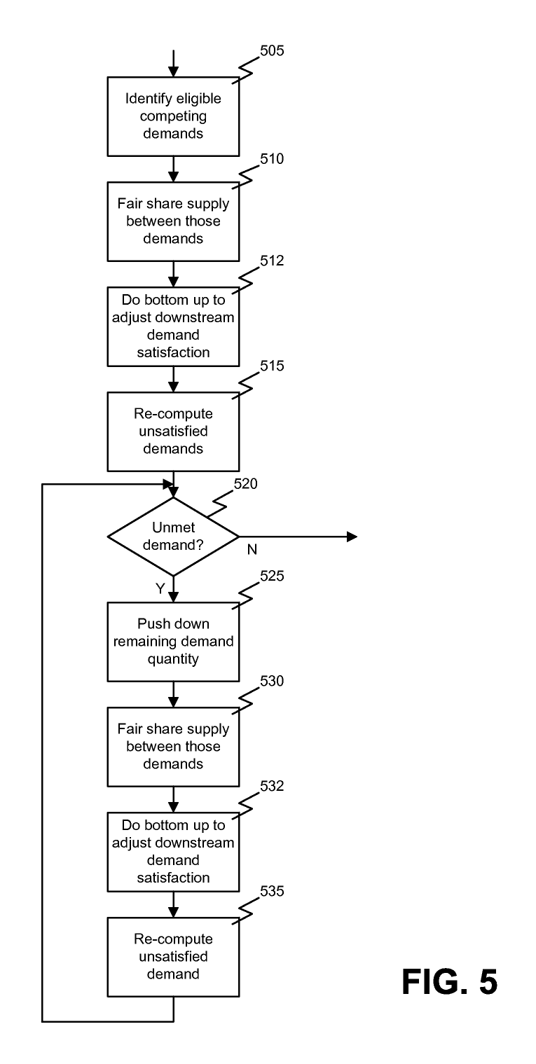

After the first round solve of main LP, post-processing heuristics can be applied 310 for fair sharing. According to one embodiment, the post-processing heuristics can use push-down logic such as described below with reference to FIG. 5 to generate the demand picture at each sourcing tier. The post-processing heuristics can also adjust the main LP solution for fair-sharing allocation requirements from the bottom up as described below with reference to FIG. 6. The output of the post-processing heuristics can include a fixed XUITC (inter-organizational transfer) variables in line with fair-sharing allocation and a fixed XFIDQ (supply towards independent demand) and fixed safety stock solution variables for end item suppression and demand satisfaction (quantity and satisfied time bucket).

Since some applications also use circular sourcing, any defined circular sourcing heuristics can be applied 315 after or in-line with fair-sharing heuristics. In circular sourcing heuristics, the firmed supply surplus and shortage can be calculated based on demand picture from fair-sharing allocation (including both independent demand and dependent demand).

Once post-processing heuristics have been applied 310 and 315, a second round solve of main LP can be executed 320 starting from demand LPs. With fixed variables passed from post-processing heuristics, the second solve of main LP can generate a solution which is in line with fair-sharing allocation requirement.

Stated another way, fair share allocation in a multi-echelon service supply chain that considers supercession and repair relationships can comprise executing 305 a first round main Linear Programming (LP) solve generated initial solution and applying 310 post-processing heuristics for fair sharing to the first round solve of the main LP after executing the first round solve of the main LP. Applying 310 the post-processing heuristics can comprise using a push-down logic to generate a demand picture for each sourcing tier of a plurality of sourcing tiers. Applying 310 the post-processing heuristics further can also comprise using a bottom-up logic to adjust the first round solve of the main LP for fair sharing allocation requirements. An output of such post-processing heuristics can comprise fixed inter-organizational transfer variables and fixed supply towards independent demand variables. In some cases, circular sourcing heuristics can also be applied 315 to the first round solve of the main LP after adjusting the first round solve of the main LP for fair sharing allocation requirements. Applying 315 the circular sourcing heuristics, if any, to the first round solve of the main LP can comprise determining a firmed supply surplus and shortage based on a demand picture from the first round solve of the main LP adjusted for fair sharing. A second round main LP solve can be executed 320 using the fixed inter-organizational transfer variables and fixed supply towards independent demand variables from the post-processing heuristics.

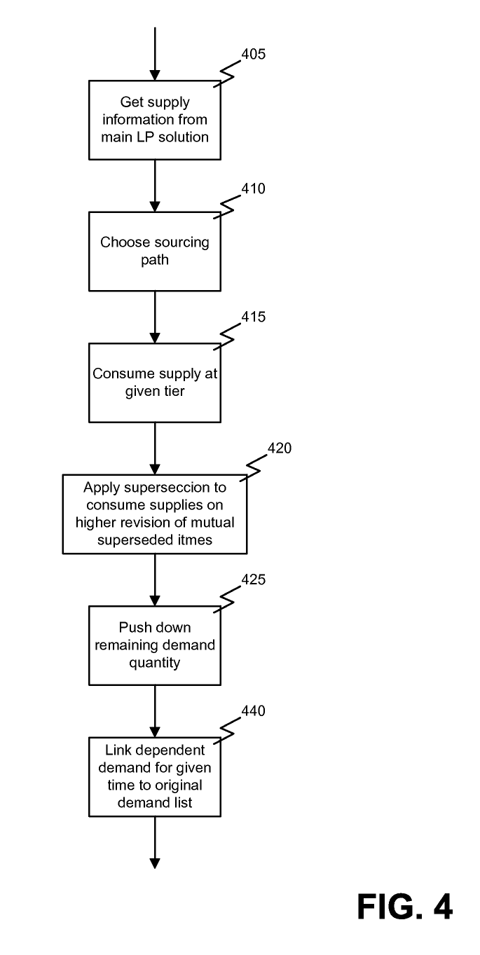

FIG. 4 is a flowchart illustrating an exemplary push-down logic process for use in fair share allocation of inventory levels throughout a supply chain according to one embodiment of the present invention. As indicated above, post-processing heuristics can be applied after the first round solve of the main LP. These heuristics can include push-down logic to generate the demand picture at each sourcing tier. As illustrated in this example, this push-down logic can begin with obtaining 405 the supply information from the main LP solution. It should be noted that in the main LP, initial solution can schedule un-firmed PO WO as early as possible. The post-processing heuristics do not generate any new supply. If appropriate, it can re-allocate the supplies used by the main LP. Since post-processing heuristics can adjust the supply allocation, the transfer planed order can be modified. As will be described in greater detail below, for each demand priority at each aggregation bucket, the push-down heuristics generate 410-445 the demand picture for each item-org at each sourcing tier. The process can then use unconstrained demand information, including demand due date and original demand item, and original demand quantity. In case of sourcing, unconstrained demand due date can be offset by lead time. In case of super-cession, the original item of the demand can be tracked.

More specifically, generating 410-445 the demand picture for each item-org at each sourcing tier can include choosing a sourcing path 410. In case there are multiple sourcing paths available, the one with the least cumulative LT can be selected. If there are multiple paths with the same cumulative LT, one path can be randomly picked. For the selected path, the supply at the given org can be consumed 415. Supercession can then be applied 420. More specifically, for any given demand, at each sourcing tier/org, the supply of the demand item at the given org can be consumed. Then, the supply of its higher revision item can be consumed, and the remaining demand quantity can be pushed down 425 to the next sourcing tier. For each time bucket, at each org for each sourcing tier a dependent demand can be linked 440 to the original demand list.

Stated another way, the flow of push-down heuristics (for supercession chain A->B->C) can be outlined as:

For each allocation time bucket (tb = 0, 1, 2, ...)

For each demand priority (from highest to lowest priority)

//Push down demands

For each sourcing tier (starting from demand org, then 1 tier
down, 2 tier down, etc.)

For each org in given sourcing tier

For each demand with the given demand priority

First consume the supply of demand item,
and track the remaining demand qty

End for each demand
// Consider item-supercession
For each revision item (item A, B, C), starting
with the lowest revision

Consume the supply of the given item to
satisfy the eligible demand, and track the
remaining demand qty

End For (each revision item)

End for (each org)
//Only the unmet demand qty will be pushed to the
orgs at the next sourcing tier

End for (each sourcing tier)
//Do fair sharing from bottom-up after pushing the demand
to very bottom tier

End for (each demand priority)

End for (each time bucket)

FIG. 5 is a flowchart illustrating an exemplary bottom-up process for use in fair share allocation of inventory levels throughout a supply chain according to one embodiment of the present invention. As indicated above, the post-processing heuristics can include bottom-up processing to adjust the main LP solution for fair-sharing allocation requirement. According to one embodiment, this process can begin with identifying 505 eligible competing demands. Once identified 505, fair sharing of supply can be applied 510 to those demands, bottom up processing 512 can be done to adjust downstream demand satisfaction, and unsatisfied demands can be re-calculated 515.

A determination 520 can then be made as to whether any unmet demand remains. In response to determining 520 that no unmet demand remains, processing may end. However, in response to determining 520 that some unmet demand remains, remaining demand quantities can be pushed down, fair sharing between the unmet demands can be applied 530, bottom up processing 532 can be done to adjust downstream demand satisfaction, and unsatisfied demand can be re-computed 535. The process of pushing down 525 remaining demand quantity, applying 530 fair sharing across those demands, bottom up processing 532 can be done to adjust downstream demand satisfaction, and re-computing 535 unsatisfied demand can be repeated until a determination 520 is made that no unmet demand remains.

Stated another way, this bottom-up logic can be outlined as follows (with item supercession A->B->C):

For each allocation time bucket (tb = 0, 1, 2, ...)

For each demand priority (from highest to lowest priority)

//Push down demands using push-down heuristics above
//Bottom up for fair-sharing
// Step 1: Check for Existing Supply
For each sourcing tier (from bottom up)

For each revision item (item A, B, C), starting with the
lowest revision

For each org with fair-sharing allocation rule

Identify competing demands that are ‘eligible’ for
the supply of the given item
Fair-share the supply of that revision between
those demands using the fair-share allocation
method selected
Re-compute the unsatisfied demands for the
various revisions

End for (each org)

End for (each org at given sourcing tier)

End For (each revision item)
//Step 2: Check for Repair (fair sharing on Good Components)
//(item super-cession) Repair is always for highest revision
If there's still unmet demand for given demand priority

Push down the remaining demand qty to repair depots and
its sourcing orgs for good components (part demands)
For each org with fair-sharing allocation rule on good
components (bottom up)

//Component supply include new buy on good
component
Fair-share the component supply between those
demands using the fair-share allocation method
selected
Re-compute the unsatisfied part demands

End for (each org)

End if

End for (each demand priority)

End for (each time bucket)

According to one embodiment, when the fair-sharing should be supported on good components of WOs, the processes described above can be modified to support these cases. For example, if the WO has more than one good components (say components B and C), then fair-sharing can be consistent on all the good components, i.e., fair-sharing quantity on components=minimum (component B qty, component C qty) with the component usage accounted. If good the component also has independent demand, then in the above heuristics, it can do fair-sharing on assembly items first, then do fair-sharing on component level (including both independent demand and component demand from assembly item).

In the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor or logic circuits programmed with the instructions to perform the methods. These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

While illustrative and presently preferred embodiments of the invention have been described in detail herein, it is to be understood that the inventive concepts may be otherwise variously embodied and employed, and that the appended claims are intended to be construed to include such variations, except as limited by the prior art.

What is claimed is:

1. A method for fair share allocation in a multi-echelon service supply chain that considers supercession and repair relationships, the method comprising:
executing a first round main Linear Programming (LP) solve generated initial solution; and
applying post-processing heuristics for fair sharing to the first round solve of the main LP after executing the first round solve of the main LP.

2. The method of claim 1, wherein applying the post-processing heuristics comprises using a push-down logic to generate a demand picture for each sourcing tier of a plurality of sourcing tiers.

3. The method of claim 2, wherein using a push-down logic to generate a demand picture for each sourcing tier comprises:
obtaining the supply information from the first round solve of the main LP;
choosing a sourcing path of a plurality of sourcing paths of the supply chain;
consuming the supply at each location for the selected path;
applying supercession at each sourcing location of the selected path;
pushing down the remaining demand quantity to a next sourcing tier; and
linking a dependent demand to the original demand list for each time bucket, at each organization for each sourcing tier.

4. The method of claim 2, wherein applying the post-processing heuristics further comprises using a bottom-up logic to adjust the first round solve of the main LP for fair sharing allocation requirements.

5. The method of claim 4, wherein an output of the post-processing heuristics comprises fixed inter-organizational transfer variables and fixed supply towards independent demand variables.

6. The method of claim 5, wherein using a bottom-up logic to adjust the first round solve of the main LP for fair sharing allocation requirements comprises:
identifying eligible competing demands;
applying fair sharing of supply to those demands;
performing bottom up processing to adjust downstream demand satisfaction;
re-calculating unsatisfied demands;
determining whether any unmet demand remains;
in response to determining unmet demand remains, repeatedly pushing down remaining demand quantities, applying fair sharing between the unmet demands, performing bottom up processing to adjust downstream demand satisfaction, and re-computing unsatisfied demand until no unmet demand remains.

7. The method of claim 5, further comprising applying circular sourcing heuristics to the first round solve of the main LP when adjusting the first round solve of the main LP for fair sharing allocation requirements.

8. The method of claim 7, wherein applying the circular sourcing heuristics to the first round solve of the main LP comprises determining a firmed supply surplus and shortage based on a demand picture from the first round solve of the main LP adjusted for fair sharing.

9. The method of claim 8, further comprising executing a second round main LP solve using the fixed inter-organizational transfer variables and fixed supply towards independent demand variables from the post-processing heuristics.

10. A system comprising:
a processor; and
a memory communicatively coupled with and readable by the processor and having stored therein a sequence of instructions which, when executed by the processor, causes the processor to perform for fair share allocation in a multi-echelon service supply chain while considering supercession and repair relationships by executing a first round main Linear Programming (LP) solve generated initial solution, applying post-processing heuristics for fair sharing to the first round solve of the main LP after executing the first round solve of the main LP, applying circular sourcing heuristics to the first round solve of the main LP when adjusting the first round solve of the main LP for fair sharing allocation requirements, wherein applying the circular sourcing heuristics to the first round solve of the main LP comprises determining a firmed supply surplus and shortage based on a demand picture from the first round solve of the main LP adjusted for fair sharing, and executing a second round main LP solve using the fixed inter-organizational transfer variables and fixed supply towards independent demand variables from the post-processing heuristics.

11. The system of claim 10, wherein applying the post-processing heuristics comprises using a push-down logic to generate a demand picture for each sourcing tier of a plurality of sourcing tiers.

12. The system of claim 11, wherein using a push-down logic to generate a demand picture for each sourcing tier comprises:
obtaining the supply information from the first round solve of the main LP;
choosing a sourcing path of a plurality of sourcing paths of the supply chain;
consuming the supply at each location for the selected path;
applying supercession at each sourcing location of the selected path;
pushing down the remaining demand quantity to a next sourcing tier; and
linking a dependent demand to the original demand list for each time bucket, at each organization for each sourcing tier.

13. The system of claim 11, wherein applying the post-processing heuristics further comprises using a bottom-up logic to adjust the first round solve of the main LP for fair sharing allocation requirements.

14. The system of claim 13, wherein an output of the post-processing heuristics comprises fixed inter-organizational transfer variables and fixed supply towards independent demand variables.

15. The system of claim 14, wherein using a bottom-up logic to adjust the first round solve of the main LP for fair sharing allocation requirements comprises:
identifying eligible competing demands;
applying fair sharing of supply to those demands;
performing bottom up processing to adjust downstream demand satisfaction;
re-calculating unsatisfied demands;
determining whether any unmet demand remains;
in response to determining unmet demand remains, repeatedly pushing down remaining demand quantities, applying fair sharing between the unmet demands, performing bottom up processing to adjust downstream demand satisfaction, and re-computing unsatisfied demand until no unmet demand remains.

16. A computer-readable memory having stored therein a sequence of instructions which, when executed by a processor, causes the processor to perform for fair share allocation in a multi-echelon service supply chain while considering supercession and repair relationships by:
executing a first round main Linear Programming (LP) solve generated initial solution;
applying post-processing heuristics for fair sharing to the first round solve of the main LP after executing the first round solve of the main LP;
applying circular sourcing heuristics to the first round solve of the main LP when adjusting the first round solve of the main LP for fair sharing allocation requirements, wherein applying the circular sourcing heuristics to the first round solve of the main LP comprises determining a firmed supply surplus and shortage based on a demand picture from the first round solve of the main LP adjusted for fair sharing; and
executing a second round main LP solve using the fixed inter-organizational transfer variables and fixed supply towards independent demand variables from the post-processing heuristics.

17. The computer-readable memory of claim 16, wherein applying the post-processing heuristics comprises using a push-down logic to generate a demand picture for each sourcing tier of a plurality of sourcing tiers.

18. The computer-readable memory of claim 17, wherein using a push-down logic to generate a demand picture for each sourcing tier comprises:
obtaining the supply information from the first round solve of the main LP;
choosing a sourcing path of a plurality of sourcing paths of the supply chain;
consuming the supply at each location for the selected path;
applying supercession at each sourcing location of the selected path;
pushing down the remaining demand quantity to a next sourcing tier; and
linking a dependent demand to the original demand list for each time bucket, at each organization for each sourcing tier.

19. The computer-readable memory of claim 11, wherein applying the post-processing heuristics further comprises using a bottom-up logic to adjust the first round solve of the main LP for fair sharing allocation requirements and wherein an output of the post-processing heuristics comprises fixed inter-organizational transfer variables and fixed supply towards independent demand variables.

20. The computer-readable memory of claim 19, wherein using a bottom-up logic to adjust the first round solve of the main LP for fair sharing allocation requirements comprises:
identifying eligible competing demands;
applying fair sharing of supply to those demands;
performing bottom up processing to adjust downstream demand satisfaction;
re-calculating unsatisfied demands;
determining whether any unmet demand remains;
in response to determining unmet demand remains, repeatedly pushing down remaining demand quantities, applying fair sharing between the unmet demands, performing bottom up processing to adjust downstream demand satisfaction, and re-computing unsatisfied demand until no unmet demand remains.
